(19) United States
(12) Patent Application Publication
(10) Pub. No.: US 2009/0119148 A1
(43) Pub. Date: May 7, 2009

(54) SYSTEM AND METHOD FOR ENHANCING PRODUCTIVITY

(75) Inventors: Patrick Joseph O'Sullivan, Ballsbridge (IE); Barry E. Willner, Briarcliff Manor, NY (US); Robert Cameron Weir, Westford, MA (US); Edith Helen Stern, Yorktown Heights, NY (US)

Correspondence Address: HOLLAND & KNIGHT, 10 ST. JAMES AVENUE, BOSTON, MA, 02116-3889, US

(73) Assignee: INTERNATIONAL BUSINESS MACHINES CORPORATION, Armonk, NY (US)

(21) Appl. No.: 11/934,496

(22) Filed: Nov. 2, 2007

(51) Int. Cl. G06F 17/30; G06F 9/46; G06F 15/02; G06F 17/00

(52) U.S. Cl. 705/9; 707/104.1; 707/E17.009

(57) ABSTRACT

A method and computer program product include defining, by a user, a time template including a plurality of predefined time intervals for scheduling meetings. The time template is applied across a collaborative system.

### TECHNICAL FIELD

This disclosure relates to time management and scheduling, and is more particularly directed at alternative time standards for time management and scheduling purposes.

### BACKGROUND

A significant source of wasted time is the general predisposition to using integral units of time, based on hour or half hour increments. This is especially true of business meetings, which are invariably scheduled to last an hour. Meeting attendees will fill the full hour for which the meeting is scheduled regardless of whether the entire hour is necessary to address the business at hand. The result of this is that a meeting that could have taken less than an hour will end up wasting time due to the arbitrary hour-based scheduling paradigm.

### SUMMARY

According to a first implementation, a method includes defining, by a user, a time template including a plurality of predefined time intervals for scheduling meetings. The time template is applied across a collaborative system.

One or more of the following features may be included. The user may include a system administrator. The plurality of time intervals may include at least a first time interval having a first duration and a second time interval having a second duration different than the first time interval. The collaborative system may include a distributed calendaring system.

Applying the time template across the collaborative system may include applying the time template across an organization-wide collaborative system. Additionally/alternatively, applying the time template across the collaborative system may include applying the time template across the collaborative system for a predefined segment of an organization.

The plurality of time intervals may vary in a predetermined pattern. The predetermined pattern includes a business cycle. Additionally, the method may further include coordinating the time template across multiple time zones.

According to another implementation, a computer program product residing on a computer readable storage medium has a plurality of instructions stored thereon. When executed by a processor, the instructions may cause the processor to perform operations including defining, by a user, a time template including a plurality of predefined time intervals for scheduling meetings. The time template is applied across a collaborative system.

One or more of the following features may be included. The user may include a system administrator. The plurality of time intervals may include at least a first time interval having a first duration and a second time interval having a second duration different than the first time interval. The collaborative system may include a distributed calendaring system.

The instructions for applying the time template across a collaborative system may include instructions for applying the time template across an organization-wide collaborative system. Additionally/alternatively, the instructions for applying the time template across the collaborative system may include instructions for applying the time template across the collaborative system for a predefined segment of an organization. Further, the plurality of time intervals may in a predetermined pattern. The predetermined pattern may include a business cycle.

The computer program product may further include instructions for coordinating the time template across multiple time zones.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a productivity enhancement process and a scheduling application coupled to a distributed computing network.

FIG. 2 is a flow chart of a process executed by the productivity enhancement process of FIG. 1.

FIG. 3 diagrammatically depicts a user interface that may be rendered by the productivity enhancement process of FIG. 1.

FIG. 4 diagrammatically depicts a user interface that may be rendered by the productivity enhancement process of FIG. 1.

FIG. 5. diagrammatically depicts a user interface that may be rendered by the productivity enhancement process of FIG. 1.

FIG. 6 diagrammatically depicts a calendar/scheduling user interface that may be rendered by the productivity enhancement process, the email client application, and/or the email server application of FIG. 1

FIG. 7 diagrammatically depicts a user interface that may be rendered by the productivity enhancement process of FIG. 1.

FIG. 8 diagrammatically depicts a user interface that may be rendered by the productivity enhancement process of FIG. 1.

FIG. 9 diagrammatically depicts a user interface that may be rendered by the productivity enhancement process of FIG. 1.

FIG. 10 diagrammatically depicts a user interface that may be rendered by the productivity enhancement process of FIG. 1.

### DETAILED DESCRIPTION

### System Overview:

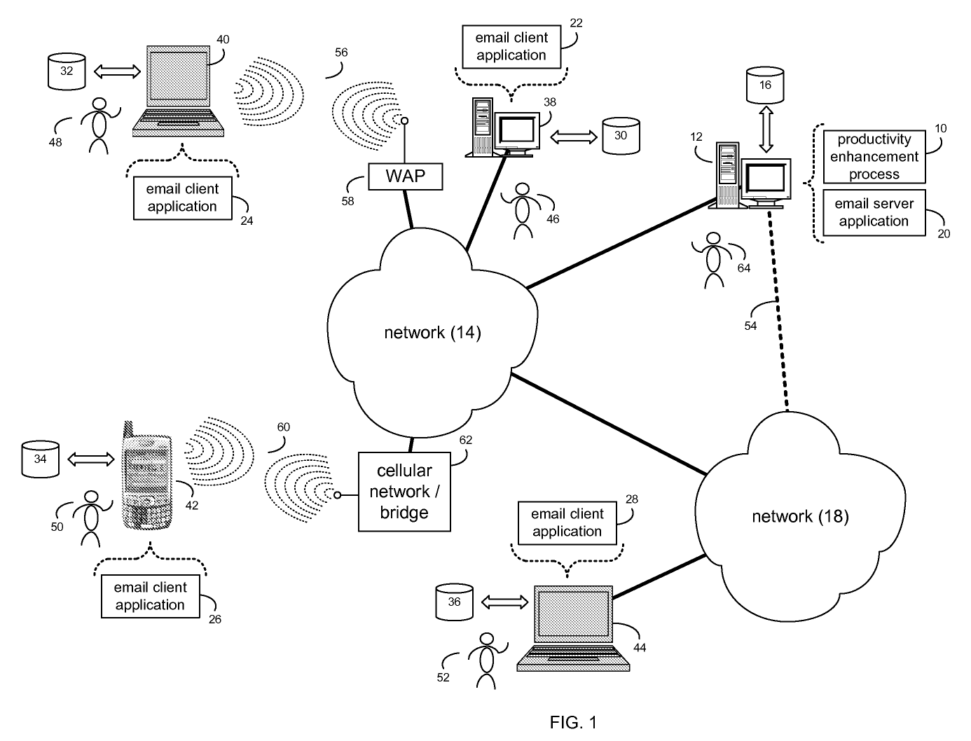

Referring to FIG. 1, there is shown productivity enhancement process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, productivity enhancement process 10 may reside on and be executed, in whole or in part, by a personal computing device, such as a personal computer, notebook computer, personal digital assistant, or the like.

As will be discussed below in greater detail, productivity enhancement process 10 may allow a user to define a time template includes a plurality of predefined time intervals for scheduling meetings. Additionally, productivity enhancement process 10 may apply the time template across a collaborative system.

The instruction sets and subroutines of productivity enhancement process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute a calendar/scheduling application, e.g., which may be a module of email server application 20, examples of which may include but are not limited to Lotus Domino™ Server and Microsoft Exchange™ Server. Mail server application 20 may store calendar and/or scheduling information for one or more calendar and/or scheduling client applications, e.g., email client applications 22, 24, 26, 28, examples of which may include but are not limited to Lotus Notes™ and Microsoft Outlook™ Additionally/alternatively, email server application 20 may be a web-based email server application that may store calendar and/or scheduling information accessible by, e.g., a web browser (not shown) that may reside on one or more client electronic devices (e.g., stored on storage devices 30, 32, 34, 36 of client electronic devices 38, 40, 42, 44). Productivity enhancement process 10 may be a stand alone application that interfaces with email server application 20 or an applet/application that is executed within email server application 20.

The instruction sets and subroutines of email server application 20, which may be stored on storage device 16 coupled to server computer 12 may be executed by one or more processors (not shown) and one or more memory architectures (not shown) incorporated into server computer 12.

As mentioned above, in addition/as an alternative to being a server-side application residing on server computer 12, the productivity enhancement process may be a client-side application (not shown) residing on one or more storage device (e.g., stored on storage device 30, 32, 34, 36) coupled to one or more client electronic device (e.g., client electronic devices 38, 40, 42, 44, respectively). As such, the productivity enhancement process may be a stand alone application that interfaces with calendar/scheduling client application (e.g., email client applications 22, 24, 26, 28), or may be an applet/application that is executed within a calendar/scheduling client application (e.g., email client applications 22, 24, 26, 28). As such, the productivity enhancement process may be a client-side process, a server-side application, or a hybrid client-side/server-side process, which may be executed, in whole or in part, by server computer 12, or one or more of client electronic device 38, 40, 42, 44.

The instruction sets and subroutines of email client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and a memory stick storage devices. Examples of computing devices 38, 40, 42, 44 may include, but are not limited to, personal computer 38, laptop computer 40, personal digital assistant 42. notebook computer 44, a data-enabled, cellular telephone (not shown), and a dedicated network device (not shown), for example. Using email client applications 22, 24, 26, 28, users 46, 48, 50, 52 may access email server application 20 and may retrieve and/or create scheduled events, such as meetings and appointments.

Users 46, 48, 50, 52 may access email server application 20 directly through the device on which the email client application (e.g., email client applications 22, 24, 26, 28) is executed, namely client electronic devices 38, 40, 42, 44, for example. Users 46, 48, 50, 52 may access email server application 20 directly through network 14 or through secondary network 18. Further, server computer 12 (i.e., the computer that executes email server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### The Productivity Enhancement Process:

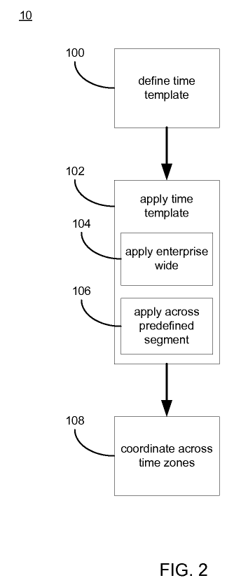

Referring also to FIG. 2, as mentioned, productivity enhancement process 10 may allow a user to define 100 a time template including a plurality of predefined time intervals for scheduling meetings. Additionally, productivity enhancement process 10 may apply 102 the time template across a collaborative system.

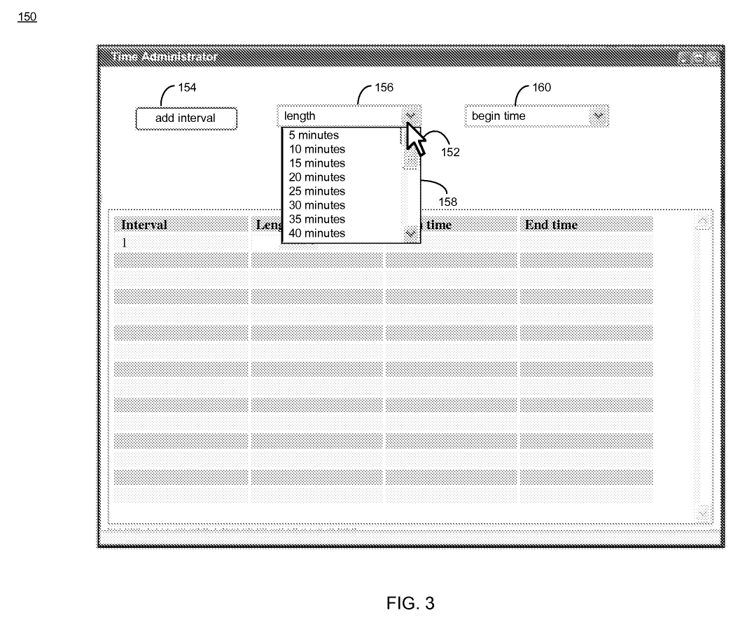

For example, and referring also to FIG. 3, productivity enhancement process 10 may allow user 64 to define 100 a time template including a plurality of predefined time intervals for scheduling meetings. Productivity enhancement process 10 may render user interface 150 through which user 63 may define a plurality of predefined time intervals. For example, user 64 may add a time interval to the time template by selecting, via onscreen pointer 152 controlled by a pointing device (e.g., a mouse; not shown), add interval button 154. Selecting add interval button 154 may result in productivity enhancement process 10 activating length drop down 156. User 64 may define a time interval length by selecting, via onscreen pointer 152, length drop down 156. Selecting length drop down 156 may result in productivity enhancement process 10 rendering length selection menu 158. User 64 may select, using onscreen pointer 152, a desired length for the time interval (e.g., 40 minutes) from time selection menu 158. Additionally, or alternatively, user 64 may input (e.g., using a keyboard; not shown) a desired length for the time interval.

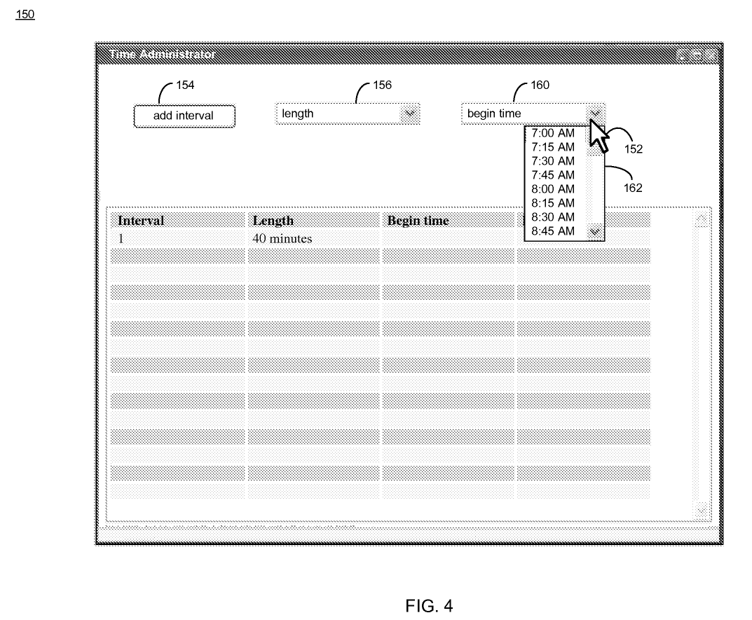

Further, and referring also to FIG. 4, user 64 may define a desired begin time for the time interval, e.g., via length drop down 160. For example, user 64 may select, via onscreen pointer 152, begin time drop down 160 resulting in productivity enhancement process 10 rendering begin time selection menu 162. Using onscreen pointer 152, user 64 may select a desired begin time (e.g., 7:00 AM) for the time interval. As with defining a desired length for the time interval, additionally/alternatively, user 64 may input (e.g., using a keyboard; not shown) a desired begin time for the tine interval.

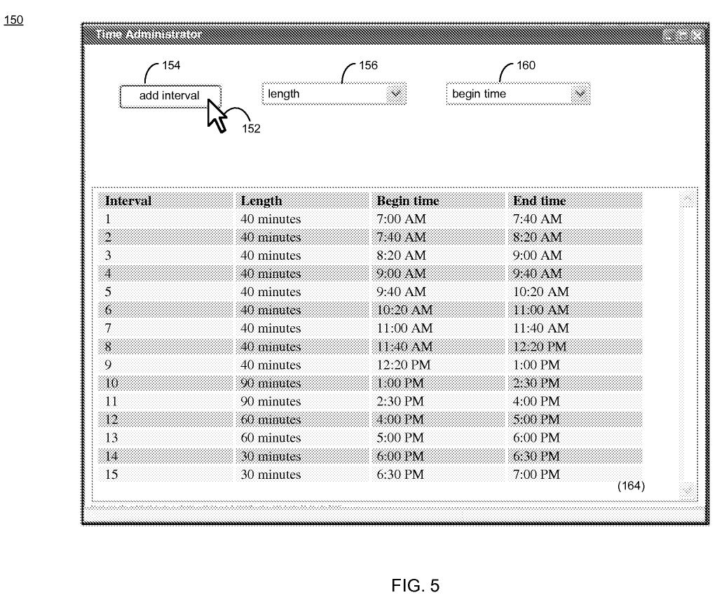

The plurality of time intervals may include at least a first time interval having a first duration and a second time interval having a second duration different than the first time interval. For example, as shown in FIG. 5, a time template 164 may include a plurality of time intervals (e.g., intervals 1-15) each having an associated length, begin time, and end time. The time template may be defined 100 as described above, e.g., by user 64 defining a respective length and begin time (with the end time being dependant upon the length and the begin time). In the time template shown in FIG. 5, intervals 1-9 (encompassing the time period between 7:00 AM and 1:00 PM) may each have a length of 40 minutes. Further, intervals 10-11 (encompassing the time period between 1:00 PM and 4:00 PM) may each have a length of 90 minutes. Intervals 12-13 (encompassing the time period between 4:00 PM and 6:00 PM) may have a length of 60 minutes. Additionally, intervals 14 and 15 (encompassing the time period between 6:00 PM and 7:00 PM) may have a length of 30 minutes. As such, time template 164 may include multiple time intervals that may be of different lengths. Other lengths, and arrangements of lengths, may also be utilized to suit specific needs, and desired timing schemes.

In the foregoing manner, user 64 may define 100 a time template including a plurality of predefined time intervals. Of course, various other interfaces and/or mechanisms may be used to define the time template including the plurality of predefined time intervals for scheduling meetings. User 64 may be, for example, a system administrator. The time template defined 100, e.g., by user 64, may be applied 102 across at least a portion of a collaborative system. Applying 102 the time template across at least a portion of a collaborative system may allow the time template, including the plurality of predefined time intervals, to be used for scheduling meetings, appointments, events, and the like. The collaborative system may include, but is not limited to, for example, a distributed calendaring/scheduling system used by one or more users (e.g., users 46, 48, 50, 52) for scheduling meetings, software enabled clocks (e.g., which may be utilized in offices, conference rooms and the like) smart watches, as well as other devices that can be used to display “corporate time” (i.e., a timing system defined by an organization such as a corporation).

The time template, including the plurality of predefined time intervals (e.g., which may be defined as described above), may be applied 102 across at least a portion of the collaborative system, e.g. by using the time template as a basis scheduling meetings via an email application (e.g., email server application 20, and email client applications 22, 24, 26, 28) which may include calendaring/scheduling modules. For example, email server application 20 may interact with productivity enhancement process 10 to apply the defined 100 time template to a calendaring/scheduling module of email server application 20 for at least a portion of users 46, 48, 50, 51 (e.g., via email client applications 22, 24, 26, 28).

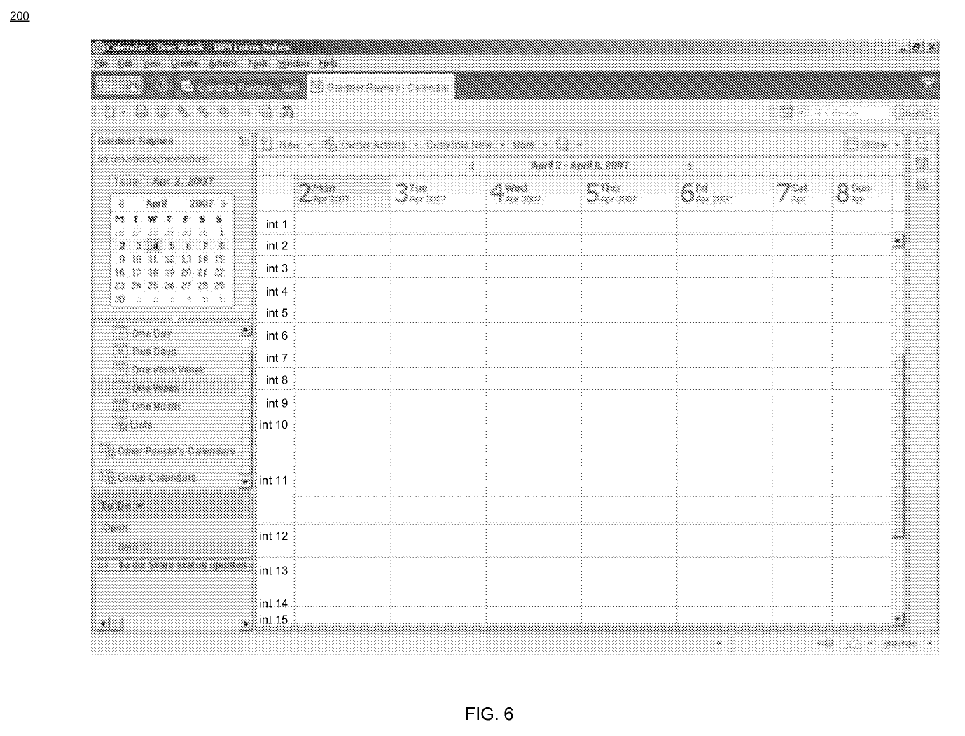

Continuing with the above-stated example, and referring also to FIG. 6, calendar/scheduling user interface 200 may be rendered by an email client application (e.g., email client application 22). Calendar/scheduling user interface 200 may allow user 46 to schedule meetings, appointments, events, and the like. Calendar/scheduling user interface 200 may partition each day into a plurality of time intervals (namely intervals “int 1” through “int 15”) in which meetings, appointments, events, and the like may be scheduled. The plurality of time intervals (namely “int 1” through “int 15”) may be based upon, at least in part time template 164 defined 100 by user 64. Consistent with time template 164, calendar/scheduling user interface 200 may include time intervals “int 1” through “int 9” of a first length (e.g., 40 minutes), time intervals “int 10” and “int 11” of a second length (e.g., 90 minutes), time intervals “int 12” and “int 13” of a third length (e.g., 60 minutes), and time intervals “int 14” and “int 15” of a fourth length (e.g., 30 minutes). Additionally, one or more of the time intervals may be capable of being divided into shorter sub-intervals. For example, as shown time intervals “int 10” and “int 11” may be divided in half, such that each interval may provide two time intervals having a length of 45 minutes.

The relatively shorter time intervals (e.g., “int 1” through “int 9” and “int 14” through “int 15”) may facilitate meetings and appointments having a relatively short anticipated duration. Additionally, the relatively shorter time intervals may force users of the collaborative system to exhibit greater efficiency. For example, with a relatively shorter scheduled time for a meeting, attendees of the meeting may be required to maintain greater focus in order to accomplish the goals of the meeting in the scheduled time. Similarly, the relatively shorter scheduled time may require more punctual arrival and greater preparation. For example, lateness in arriving at the meeting and lack of preparation may result in the inability to accomplish the goals of the meeting. With this knowledge, meeting attendees may make a greater effort to ensure that necessary goals can be accomplished within the relatively shorter time period scheduled for the meeting. Relatively longer time intervals (e.g., “int 10” through “int 13”) may accommodate longer and/or more involved meetings.

Applying 102 the time template across the collaborative system may include applying 104 the time template across an organization-wide collaborative system. For example, time template 164 defined 100 by user 64 and applied 102 across a collaborative system for an entire organization (e.g., the time template may be applied to an entire organization, such as a company). As such, time template 164 may be implemented for all scheduling of meetings, appointments, events and the like, for all users within an organization.

Additionally/alternatively, applying 102 the time template across the collaborative system may include applying 106 the time template across the collaborative system for a predefined segment of an organization. For example, time template 164 defined 100 by user 64 may only be applied to a portion of the users within an organization (such as a company). The predefined segment of an organization may include one or more departments within an organization (e.g., time template 164 may be applied 106 to a software development department but not to the marketing department). Similarly, the predefined segment of the organization may include a geographic segment of the organization. For example, time template 164 may be applied 106 to a calendar/scheduling system for a company's Cambridge, Mass. office only.

The plurality of time intervals may vary in a predetermined pattern. For example, the plurality of time intervals may vary throughout the calendar year. In one example, the plurality of time intervals may vary in a predetermined pattern including a business cycle (e.g., based on yearly quarters, the end of the fiscal year, etc). For example, the time template may vary to provide a greater number of uniform time intervals at the end of the calendar year, e.g., to increase efficiency by allowing for a greater number of meetings, appointments, or events of a shorter duration.

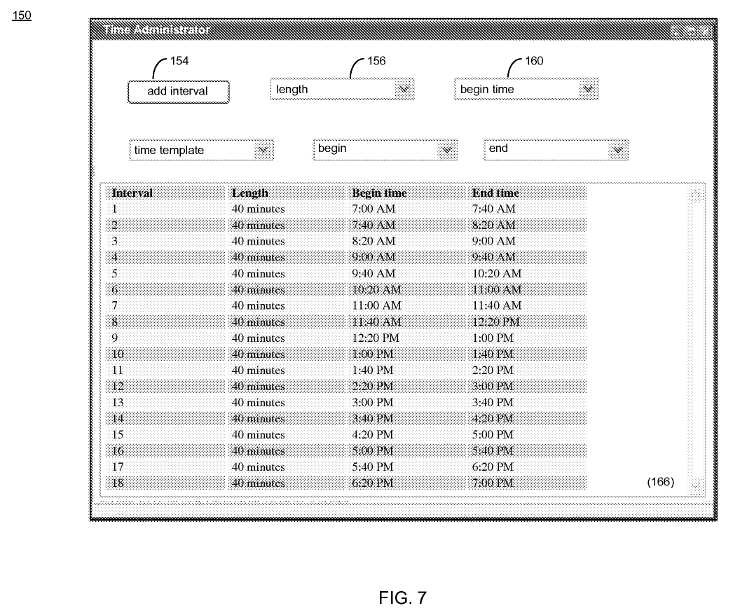

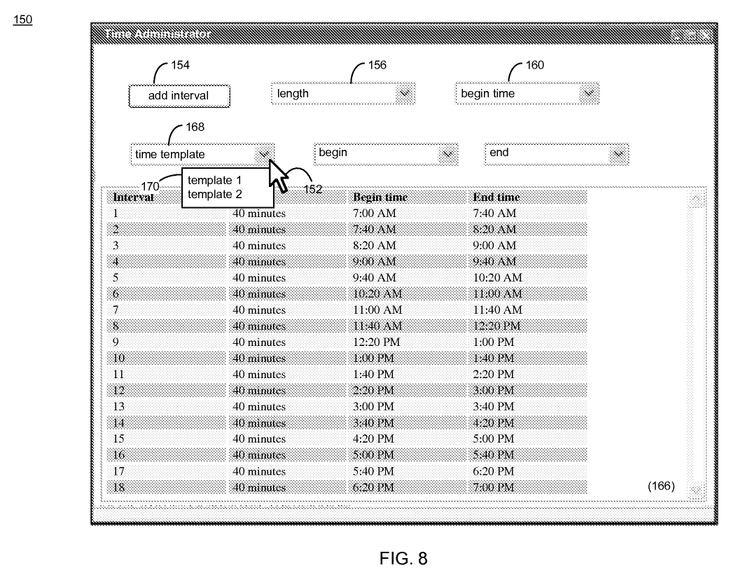

Varying the plurality of time intervals may include defining 100 a first time template, including a plurality of predefined time intervals, and defining 100 a second time template, including a plurality of predefined time intervals. Referring also to FIG. 7, as described above, user 64 may define 100 second time template 166 including 18 predefined time intervals (namely intervals 1-18) each having a length of 40 minutes. Referring also to FIG. 8, user 64 may apply 102 second time template 166 across the collaborative system during a predetermined period of time (e.g., during the last month of the fiscal year ending December 31^{st}). Productivity enhancement process 10 may allow user 64 to select a time template to be applied during a specified time period. For example, user 64 may select, via onscreen pointer 152, time template drop down 168. Selecting time template drop down 168 may result in productivity enhancement process 10 rendering time template selection menu 170. User 64 may select a desired time template (e.g., template 2) from time template selection menu 170 using onscreen pointer 152.

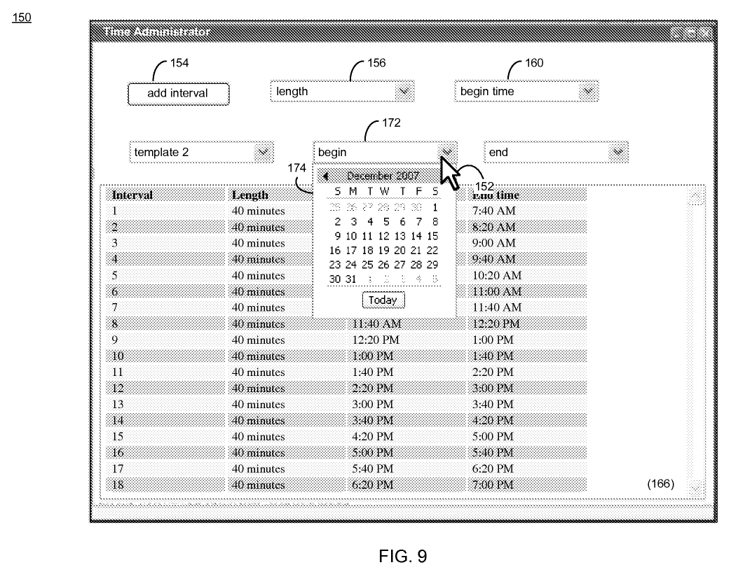

Referring also to FIG. 9, productivity enhancement process 10 may also allow user 64 to select a start date for applying the selected time template (e.g., template 2). For example, user 64 may select, via onscreen pointer 152, begin drop down 172. Selecting begin drop down 172 may result in productivity enhancement process 10 rendering begin calendar 174. User 64 may select, via onscreen pointer 152, a desired start date (e.g., December 1^{st} for the last month of the fiscal year) from begin calendar 174.

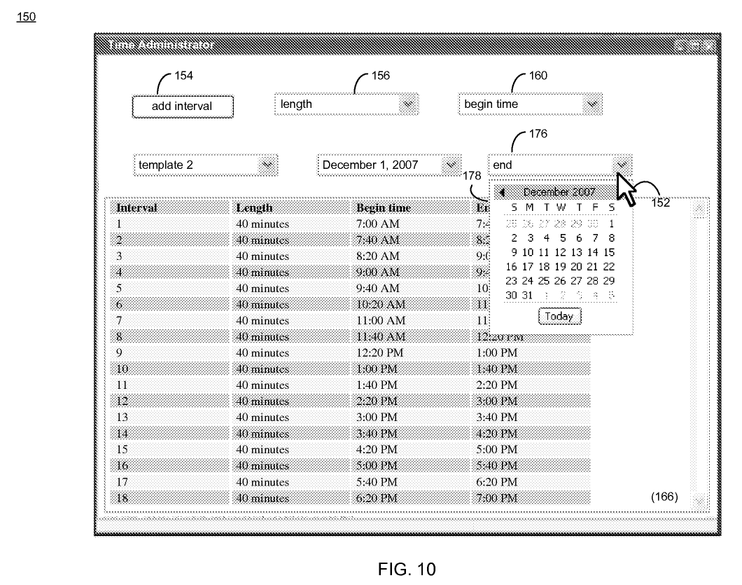

Referring also to FIG. 10, productivity enhancement process 10 may also allow user 64 to select an end data for applying the selected time template (e.g., template 2). For example, user 64 may select, via onscreen pointer 152, end drop down 176, resulting in productivity enhancement process 10 rendering end calendar 178. User 64 may select, via onscreen pointer 152, a desired end date (e.g., December 31^{st} for the end of the fiscal year) from end calendar 178. In the foregoing manner, productivity enhancement process 10 may allow user 64 to apply 102 time template 2 across the collaborative system for scheduling meetings, appointments, events, and the like, during the last month of the fiscal year (e.g., between December 1^{st} and December 31^{st}).

Additionally, productivity enhancement process 10 may allow one or more time templates to be coordinated across multiple time zones. For example, the time templates utilized in connection with collaborative systems in different time zones may be defined 100 to include predefined time intervals that facilitate scheduling a common meeting across multiple time zones. For example, at least a portion of the predefined time intervals of the one or more time templates may utilize one or more 15 minute, 30 minute, 60 minute, etc. time intervals that may allow coordination across multiple time zones. Other arrangements may also be used to facilitate coordination of time templates across multiple time zones.

The observation is that if an hour were shorter, by a small amount, we would be more focused, and accomplish the same amount of work, but in less real time, thereby increasing productivity.

What is claimed is:

1. A method including:
defining, by a user, a time template including a plurality of predefined time intervals for scheduling meetings; and
applying the time template across a collaborative system.

2. The method of claim 1, wherein the user includes a system administrator.

3. The method of claim 1, wherein the plurality of time intervals includes at least a first time interval having a first duration and a second time interval having a second duration different than the first time interval.

4. The method of claim 1, wherein the collaborative system includes a distributed calendaring system.

5. The method of claim 1, wherein applying the time template across a collaborative system includes applying the time template across an organization-wide collaborative system.

6. The method of claim 1, wherein applying the time template across the collaborative system includes applying the time template across the collaborative system for a predefined segment of an organization.

7. The method of claim 1, wherein the plurality of time intervals varies in a predetermined pattern.

8. The method of claim 7, wherein the predetermined pattern includes a business cycle.

9. The method of claim 1, further including coordinating the time template across multiple time zones.

10. A computer program product residing on a computer readable storage medium having a plurality of instructions stored thereon, which, when executed by a processor, cause the processor to perform operations comprising:
defining, by a user, a time template including a plurality of predefined time intervals for scheduling meetings; and
applying the time template across a collaborative system.

11. The computer program product of claim 10, wherein the user includes a system administrator.

12. The computer program product of claim 10, wherein the plurality of time intervals includes at least a first time interval having a first duration and a second time interval having a second duration different than the first time interval.

13. The computer program product of claim 10, wherein the collaborative system includes a distributed calendaring system.

14. The computer program product of claim 10, wherein the instructions for applying the time template across a collaborative system include instructions for applying the time template across an organization-wide collaborative system.

15. The computer program product of claim 10, wherein the instructions for applying the time template across the collaborative system include instructions for applying the time template across the collaborative system for a predefined segment of an organization.

16. The computer program product of claim 10, wherein the plurality of time intervals varies in a predetermined pattern.

17. The computer program product of claim 16, wherein the predetermined pattern includes a business cycle.

18. The computer program product of claim 10, further including instructions for coordinating the time template across multiple time zones.
